(19) United States
(12) Patent Application Publication
(10) Pub. No.: US 2026/0052361 A1
(43) Pub. Date: Feb. 19, 2026

(54) VEHICLE CONTROL SYSTEM

(71) Applicant: Transportation IP Holdings, LLC, Norwalk, CT (US)

(72) Inventor: Ann Kristina Grimm, Cedar Rapids, IA (US)

(73) Assignee: Transportation IP Holdings, LLC, Norwalk, CT (US)

(21) Appl. No.: 18/809,164

(22) Filed: Aug. 19, 2024

(51) Int. Cl. H04W 4/44; B60K 35/21; G01S 19/03; H04W 4/029

(52) U.S. Cl. CPC H04W 4/44; B60K 35/21; G01S 19/03; H04W 4/029

(57) ABSTRACT

An apparatus for determining position uncertainty of a vehicle in proximity to a wayside device, the apparatus comprises a control circuit located on-board a vehicle comprising a leading edge. The control circuit is configured to receive a wayside signal from a wayside device positioned along a route to be traveled by the vehicle and receive a leading edge signal from a positioning system. The wayside signal represents a location of the wayside device. The leading edge signal represents a location of the leading edge of the vehicle. The control circuit is configured to determine a distance between the leading edge of the vehicle based on the leading edge signal received from the positioning system and the location of the wayside device associated with the wayside signal, calculate a position uncertainty of the leading edge of the vehicle, and determine whether the wayside device is within the position uncertainty.

### BACKGROUND

### Technical Field

The subject matter described herein relates to systems and methods for controlling the movement of vehicles.

### Discussion of Art

Many different types of vehicles (e.g., automobiles, rail vehicles, buses, trucks, mining vehicles, manned or unmanned aircraft, agricultural vehicles, marine vessels, etc.) may use navigation systems to control when, where, and/or how the vehicles move along routes between locations. Devices may also be present along the route traveled by the vehicles which provide information indicative of whether, and under what conditions, the vehicles can proceed along the route. To control movement of the vehicles it can be important to know with relative certainty the location of the vehicle.

As one example of such a navigation system, some rail vehicles may use vehicle control systems to control where, when, and/or how the rail vehicles may move to avoid collisions between the vehicles, to avoid moving in unsafe manners (e.g., too fast through curves or through areas where maintenance crews are present, etc.), and the like. One example of such a navigation system is a Positive Train Control (PTC) system. The PTC system typically includes both off-board and onboard components. Vehicles may report positions, speeds, etc. to the off-board component of the PTC system. The off-board component can monitor the status of wayside devices and the movements of many vehicles based on these reports, and can send instructions (e.g., movement authorities) that inform the onboard components of various information, including which segments of routes that the vehicles can safely enter into, how fast the vehicles can move in different segments of the routes, etc., to help prevent collisions and/or ensure the vehicles are otherwise moving in safe ways.

For these control systems to be able to operate, the control systems may require that a leading edge of a vehicle be known. Currently, these control systems may require that a global navigation satellite system (GNSS) signal be received to determine the possible leading edge. The GNSS signal can be a signal that includes or represents a geographic position (latitude, longitude, and/or altitude) of the vehicle, and can be obtained by a GNSS receiver (e.g., a Global Positioning System, or GPS, receiver) onboard the vehicle that receives signals from off-board GNSS components (e.g., GNSS satellites). In some circumstances the ability to always receive GNSS signals, and/or the precision with which the location of the leading edge of the vehicle can be determined thereby, may be less than desired.

While some known control systems may rely on the addition of sensors, new signals and/or sources of those signals to determine locations of vehicles in relation to signals along a route, these other known control systems may increase the cost and complexity of operating the vehicles. It may be desirable to have a vehicle control system and method that differs from those that are currently available.

### BRIEF DESCRIPTION

In one example, an apparatus may include a control circuit located on-board a vehicle comprising a leading edge. The control circuit is configured to receive a wayside signal from a wayside device positioned along a route to be traveled by the vehicle. The wayside signal represents a location of the wayside device. The control circuit is configured to receive a leading edge signal from a positioning system. The leading edge signal represents a location of the leading edge of the vehicle. The control circuit is configured to determine a distance between the leading edge of the vehicle based on the leading edge signal received from the positioning system and the location of the wayside device associated with the wayside signal, calculate a position uncertainty of the leading edge of the vehicle, and determine whether the wayside device is within the position uncertainty.

In one example, an apparatus may include a user interface coupled to a control circuit located on-board a vehicle comprising a leading edge. The user interface is configured to display a first icon representing a wayside device at a location of the wayside device, a second icon representing the vehicle at a location of the vehicle, and an indication of whether the wayside device is within the position uncertainty or outside the position uncertainty.

In one example, a method may include receiving a wayside signal, where the wayside signal represents a location of a wayside device, and receiving a leading edge signal, where the leading edge signal represents a location of a leading edge of the vehicle. The method may include determining a distance between the leading edge of the vehicle based on the leading edge signal and the location of the wayside device associated with the wayside signal, calculating a position uncertainty of the leading edge of the vehicle, and determining whether the wayside device is located within the position uncertainty.

### BRIEF DESCRIPTION OF THE DRAWINGS

The subject matter may be understood from reading the following description of non-limiting embodiments, with reference to the attached drawings, wherein below:

FIG. 1 illustrates one example of a route with a vehicle approaching a wayside device;

FIG. 2 illustrates a vehicle control system according to one embodiment;

FIG. 3 illustrates a vehicle approaching a wayside device outside a position uncertainty of the vehicle according to one embodiment;

FIG. 4 illustrates a vehicle approaching a wayside device outside a position uncertainty of the vehicle according to one embodiment;

FIG. 5 illustrates a vehicle approaching a wayside device within a position uncertainty of the vehicle according to one embodiment;

FIG. 6 illustrates a vehicle passing a wayside device within a position uncertainty of the vehicle according to one embodiment;

FIG. 7 illustrates a vehicle passing a wayside device outside a position uncertainty of the vehicle according to one embodiment;

FIG. 8 illustrates one embodiment of a user interface for indicating position uncertainty of a vehicle in proximity to a wayside device;

FIG. 9 illustrates one embodiment of a method for determining position uncertainty of a vehicle in proximity to a wayside device.

### DETAILED DESCRIPTION

Various aspects of the present disclosure relate to vehicle control systems and methods for controlling the movement of vehicles along routes between different locations. Uncertainty in location of a vehicle may occur in areas where the vehicles may be unable to accurately (e.g., correctly) and/or precisely (e.g., with an acceptable range of error) determine the locations of the leading edge of vehicles or due to errors in track data, wheel size, or wheel slip/slide. These determined locations may be used by the vehicle control systems to assist the vehicles in safe movement, such as by instructing onboard components of the vehicle control systems when, where, and/or how the vehicles can safely travel through or on different segments of routes and whether to stop or proceed at wayside devices/signals.

A wayside device may be at least one of switches, track circuits and grade crossings which can be monitored to obtain their status in terms of Positive Train Control. The wayside device may be along a highway route or be a remote device along a route which a vehicle travels.

For example, when a Positive Train Control (PTC) system such as a Interoperable Electronic Train Management System (I-ETMS) is utilized, there can be uncertainty as to the exact location of the leading edge of the train due to several error sources including, but not limited to, error in the location information provided by GPS (or equivalent satellite navigation systems), error in track data, error in wheel size, and error introduced by wheel slip/slide.

An I-ETMS on-board segment may provide a continuous calculation of position uncertainty as the vehicle moves along a route. The I-ETMS may reset the position uncertainty value when a valid GPS fix is received and may increment the value of uncertainty as the system dead reckons between GPS fixes as potential errors in location accumulate.

A wayside device may be controlled either directly or indirectly by a railroad dispatcher and can be interlocked with electrical track circuits. The wayside device may send a signal indicating a restrictive indication, such as ““Stop,”” for several reasons. For example, a wayside signal may indicate a restrictive indication when a railroad dispatcher commands the signal to give a restrictive indication, when a vehicle occupies the track circuit associated with the signal (e.g., this may be the train whose movement is governed by the signal or another train entering the track circuit from another location), or when there is a broken rail interrupting the current in the track circuit. The I-ETMS on-board segment may have access only to information on the signal indication, not the cause of that indication.

One goal for a PTC system is to prevent a vehicle from passing a wayside device with a signal with a stop indication and thus exceeding the movement authority of the vehicle. When a vehicle is approaching a wayside device, the I-ETMS on-board segment should accept a downgrade in the indication of that signal and generate a stop target to prevent the train from passing the wayside device.

Another requirement of a PTC system is that the PTC system must not falsely enforce a restrictive indication on a vehicle when that vehicle “knocks down” a permissive signal indication in the process of passing that wayside device. For example, when a vehicle has passed a wayside device, the I-ETMS on-board segment should ignore a downgrade in the indication of that signal and not generate a stop target for the vehicle since it is likely that the signal downgraded as a result of this vehicle occupying the associated track circuit.

When the leading edge of the vehicle and a wayside device are closer together than the calculated position uncertainty, the I-ETMS on-board segment may not be able to determine for certain which side of the wayside device the leading edge of the train is on. This makes it difficult for the I-ETMS on-board segment to infer the cause for a downgrade in the signal indication and perform the correct functionality.

Various subject matter disclosed herein relates to the addition and/or enhancement of functionality of a PTC system, for example the I-ETMS on-board segment, to indicate when the leading edge of the train is within the calculated position uncertainty of a wayside device or is about to be within the calculated position uncertainty of a wayside device. This will assist the system, and/or the user, in determining where to stop the vehicle in relation to the signal, ideally making such determination at a distance greater than the calculated position uncertainty. This can help minimize the possibility that the I-ETMS on-board segment either erroneously generates an unwarranted stop target, leading to operational delays, or fails to generate a stop target, potentially leading to a false proceed.

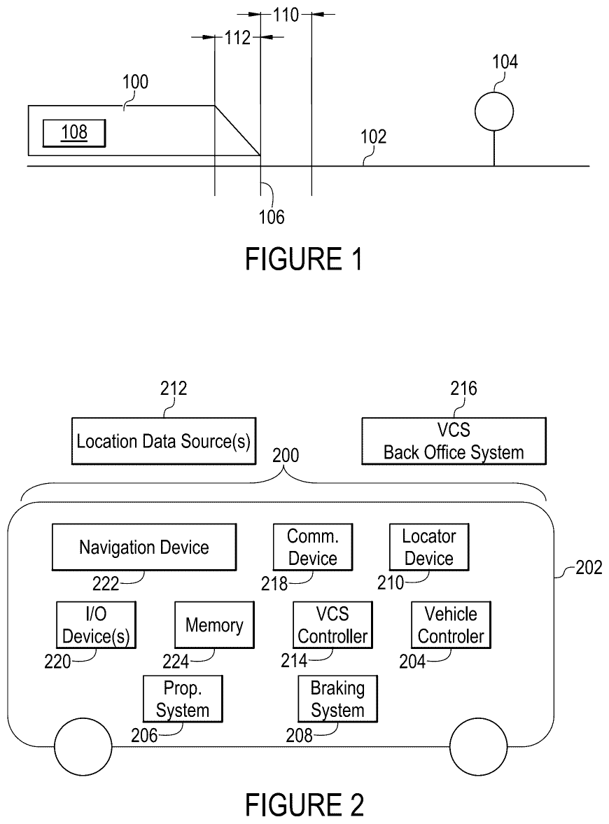

FIG. 1 illustrates one example of a route 102 with a vehicle 100 approaching a wayside device 104. The vehicle includes a leading edge 106 at the proximal end of the vehicle. The vehicle may include wheels to move along the route. A control circuit 108, which can be located on-board the vehicle, may control operation of the vehicle as discussed herein.

The route can represent roads, tracks, lanes of the same or neighboring roads, paths, waterways, or other vehicle routes on which vehicle systems may travel. The vehicle can represent a single vehicle or multi-vehicle systems formed from multiple vehicles. The vehicles in the multi-vehicle system can be mechanically coupled with each other or may be separate but have coordinated movement so that the vehicles in the vehicle system can move together (e.g., in a platoon, convoy, swarm, etc.). The vehicles can be propulsion-generating vehicles (e.g., automobiles, trucks, locomotives, etc.). In the multi-vehicle systems, one or more (but fewer than all) of the vehicles can represent non-propulsion-generating vehicles (e.g., trailers, railcars, etc.).

With continued reference to the vehicle and route shown in FIG. 1, FIG. 2 illustrates one embodiment of a vehicle control system 200. The vehicle control system may be off-board and/or onboard a vehicle 202, such as a propulsion-generating vehicle. The vehicle shown in FIG. 2 can represent the vehicle 100 shown in FIG. 1. The vehicle control system 200 in FIG. 2 can represent the control circuit of FIG. 1. One or more components of the vehicle control system may be off board the vehicle while one or more other components of the vehicle control system may be on-board the vehicle. Alternatively, all components of the vehicle control system may be on-board the vehicle.

A vehicle controller 204, or control circuit, controls the operation (e.g., movement) of the vehicle. The vehicle controller can represent hardware circuitry that includes and/or is connected with one or more processors (e.g., microprocessors, integrated circuits, field programmable gate arrays, etc.) that perform the operations described in connection with the vehicle controller. For example, the vehicle controller can communicate with a propulsion system 206 (“Prop. System” in FIG. 2, such as one or more engines, motors, or the like) to control propulsion of the vehicle and vehicle system, and/or a braking system 208 (e.g., one or more friction brakes, air brakes, or the like) to slow or stop movement of the vehicle and vehicle system. In other embodiments, the vehicle controller, or control circuit, may be implemented in logic, such as, a programmable logic device (PLD) or field programmable gate array (FPGA), for example.

A locator device 210 may determine the geographic locations of the vehicle. In one embodiment, the locator device communicates with one or more location data sources 212 that are off board the vehicle to determine the locations of the vehicle and a leading edge of the vehicle. For example, the location data sources can represent GNSS satellites or beacons that broadcast signals that are received by the locator device (e.g., a GNSS or GPS receiver). The locator device can determine the location, heading, speed, etc. of the vehicle based on these signals. Alternatively, the locator device can include a sensor that detects one or more characteristics to determine the locations of the vehicle. For example, the locator device can represent a radio frequency identification (RFID) reader that reads an RFID tag associated with a known location to determine the vehicle location. As another example, the locator device can represent an optical sensor, such as a camera, that optically reads where the vehicle is located (e.g., from one or more signs, such as waypoints, road signs, etc.). In one example, the locator device (and/or the vehicle controller) can apply one or more filters to the signals received from the location data source(s), such as a Kalman filter.

A vehicle control system controller 214 (“VCS Controller” in FIG. 2) represents an onboard component of the vehicle control system. The VCS controller can communicate with an off-board component of the vehicle control system, such as a vehicle control system back-office system 216 (“VCS Back Office System” in FIG. 2). The VCS controller and the back-office system can communicate with each other via a communication device 218 (“Comm. Device” in FIG. 2), which can represent hardware transceiving circuitry, such as a transceiver, modem, antenna, and the like. The back-office system also can include a communication device 218 to allow for communication with the vehicles. The VCS controller can represent hardware circuity that includes and/or is connected with one or more processors. The VCS controller can communicate with the back-office system to report locations of the vehicle, moving speeds of the vehicle, headings, or directions of movement of the vehicle, etc. The VCS controller also can receive directive signals from the back-office system. These signals can include movement restrictions, such as movement authorities that dictate where, when, and/or how the vehicle can move. The back-office system can determine whether to allow different vehicles to enter into different route segments and/or how the vehicles can move in those segments based on reported locations, speeds, and/or headings of the vehicles, as well as reported areas of the routes undergoing repair, maintenance, etc.

For example, the back-office system and the VCS controller can be components of a positive control system that sends movement authorities to vehicles to inform the vehicles whether the vehicles can travel into an upcoming segment of a route, how fast the vehicles can move in the upcoming segment of the route, etc. If the VCS controller receives a permissive movement authority from the back office system indicating that the vehicle can enter into the upcoming segment, then the VCS controller can inform the operator (e.g., via an input and/or output device 220, or “I/O Device” in FIG. 2) of whether the vehicle can move into the upcoming segment (and optionally how fast the vehicle can move in the upcoming segment). Optionally, the VCS controller can allow the vehicle to move into the upcoming segment responsive to receiving the movement authority. But if the VCS controller does not receive the movement authority, then the VCS controller may inform the operator of the vehicle and/or generate signals to automatically control the propulsion system and/or braking system to prevent the vehicle from entering into the upcoming segment of the route and/or to prevent the vehicle from moving in the upcoming segment of the route in a way that violates the movement authority (e.g., moving faster than the movement authority dictates).

As another example, the back-office system and the VCS controller can be components of a negative control system that sends movement authorities to vehicles to inform the vehicles where the vehicles cannot travel. If the VCS controller receives a movement authority from the back-office system indicating that the vehicle cannot enter into the upcoming segment, then the VCS controller can inform the operator and/or automatically control the propulsion system and/or braking system to prevent disallowed movement of the vehicle in the upcoming segment. If the VCS controller does not receive the movement authority from the back-office system indicating that the vehicle cannot enter into the upcoming segment, then the VCS controller can inform the operator and/or allow movement of the vehicle in the upcoming segment.

A navigation device 222 can determine locations of the vehicle based off information other than or in addition to the off-board signals received from the location data source(s). For example, the navigation device can include or represent one or more sensors that detect movement of the vehicle. These sensors can include one or more IMUs, accelerometers, magnetometers, tachometers (e.g., wheel and/or other tachometers), etc. The navigation device optionally can include one or more processors that examine the information sensed by the sensors to determine the movement and/or change in location of the vehicle. Alternatively, the navigation device may include the sensor(s) but may send the output from the sensor(s) to the VCS controller and/or the vehicle controller to calculate the location of the vehicle based on the sensor output. The navigation device and/or the vehicle controller can apply one or more filters, such as a Kalman filter, to the output of the sensor(s). In one embodiment, the navigation device (or the controller(s)) can employ a dead reckoning calculation, a wireless triangulation calculation, or the like, to monitor or determine the location(s) of the vehicle in locations and/or during times when the locator device is unable to do so and/or the locator device is unable to receive the signals from the location data source(s). In one embodiment, a locator device can determine a position uncertainty based on data and errors.

The I/O device referred to above can represent a display screen, a touchscreen, a speaker, or the like, which is used to communicate information with an operator onboard the vehicle. A tangible and computer-readable storage medium (e.g., a computer hard drive, disc, removable memory, etc.), or memory 224, optionally can be onboard the vehicle. This memory can store information determined by the navigation device, controller(s), and/or locator device, such as a last-known location determined from the off-board signals received from the location data source(s), the location determined by the navigation device or controller(s) based on the output from the navigation device (e.g., the dead-reckoning determined location), or the like. The memory optionally can store route layouts, such as a map or other information on the locations, curves, paths, etc. of various routes on which the vehicle may or will travel.

In operation, one embodiment of the control system can initiate a trip of the vehicle (or a multi-vehicle system that includes the vehicle) by obtaining one or more off-board signals from the location data source(s) and determine the geographic location of the vehicle. The VCS controller can examine this location and the route layouts (e.g., as obtained from the memory and/or received from a communication from the back-office system) to determine which route the vehicle is located. For example, the VCS controller can determine whether the geographic location of the vehicle as determined by the locator device is on or near a route (e.g., within a threshold distance, such as three meters or a distance between neighboring routes). The VCS controller can identify this route as the route currently occupied by the vehicle and on which the vehicle will begin the trip. The VCS controller can communicate this identified route to the back-office system so the back-office system can determine where the vehicle is located to determine which route segments that the vehicle can enter into, how fast the vehicle can move through the route segments, and the like.

Turning back to FIG. 1, as the vehicle 100 approaches the wayside device 104, an embodiment of the control circuit 108 located on-board the vehicle 100 may control the operation of the vehicle as the vehicle is in proximity of the wayside device. As shown, the leading edge of the vehicle is farther from the wayside device than a distance equal to the calculated position uncertainty. The wayside device is not within the position uncertainty of the leading edge of the vehicle.

The control circuit may receive a wayside signal from the wayside device positioned along the route to be traveled by the vehicle. The wayside signal may represent a location or position of the wayside device. For example, the location of the wayside device may be GPS coordinate. The location of the wayside device may be a location along a route or a distance from the vehicle to the wayside device. In another embodiment, the location of the wayside device is known based on route data stored by the vehicle or based on route data received from the back office.

The wayside signal also may include a status of the wayside device. The status may be an indication if the vehicle may proceed, e.g., a stop indication or proceed indication.

The control circuit may receive a leading edge signal from a positioning system. The leading edge signal represents a location of the leading edge of the vehicle. The leading edge of the vehicle may be the proximal most edge of the vehicle. The positioning system may be a global positioning system (GPS) or the locator device 210 as shown in FIG. 2.

The control circuit may determine a distance between the leading edge of the vehicle based at least partly on the leading edge signal received from the positioning system and the location of the wayside device associated with the wayside signal. The control circuit may determine the distance based on the leading edge of the vehicle and the location of the wayside device. For example, the control circuit may determine the distance between the leading edge of the vehicle and the location of the wayside device by comparing the location of the leading edge of the vehicle and the location of the wayside device.

The control circuit may calculate a position uncertainty of the leading edge of the vehicle. The position uncertainty may be a distance from the leading edge of the vehicle. The position uncertainty may include a position uncertainty ahead of the vehicle's leading edge, a position uncertainty behind the vehicle's leading edge, or both. The position uncertainty ahead and behind may be the same.

To determine the position uncertainty of the leading edge of the vehicle, the control circuit may receive a GPS signal and upon receipt of the GPS signal, may set the position uncertainty to a minimum distance. The minimum distance may be based at least partly on at least one of speed of the vehicle, the accuracy of the GPS receiver onboard the vehicle, whether the GPS receiver is using a differential GPS (DGPS) correction service, or combinations thereof.

The control circuit may increment the position uncertainty over time. For example, after the receipt of the GPS signal the position uncertainty may be incremented based on at least one of an error in track size or an error in wheel size. In one embodiment, the position uncertainty may reset to the minimum distance upon receipt of the GPS signal and then the position uncertainty may be incremented until the next GPS signal is received. The position uncertainty may be incremented based on at least one of an error in track size or an error in wheel size, wheel slip/slide, or combinations thereof. A vehicle wheel may slip and turn more than expected. During a wheel slip, the vehicle may indicate more distance was traveled than the vehicle actually traveled. A wheel may slide and turn less than expected. During a wheel slide, the vehicle may indicate less distance was travelled than the vehicle actually travelled.

The control circuit may determine whether the wayside device is within the position uncertainty of the leading edge of the vehicle. For example, the control circuit may compare the position uncertainty with the distance from the leading edge of the vehicle to the wayside device. If the position uncertainty is greater than the distance from the leading edge of the vehicle to the wayside device, then the wayside device is within the position uncertainty. If the position uncertainty is less than the distance from the leading edge of the vehicle to the wayside device, then the wayside device is not within the position uncertainty. As shown, the wayside device is not within the position uncertainty of the leading edge of the vehicle.

Based at least partly on the location of the wayside device associated with the wayside signal and the calculated position uncertainty of the leading edge of the vehicle based on the leading edge signal, the control circuit may be configured to execute one of: controlling a speed of the vehicle in motion, or stop a movement of the vehicle.

For example, controlling the speed of the vehicle may include decreasing the speed of the vehicle, maintaining the speed of the vehicle, or increasing the speed of the vehicle. For example, stopping the movement of the vehicle may include initiating the braking system.

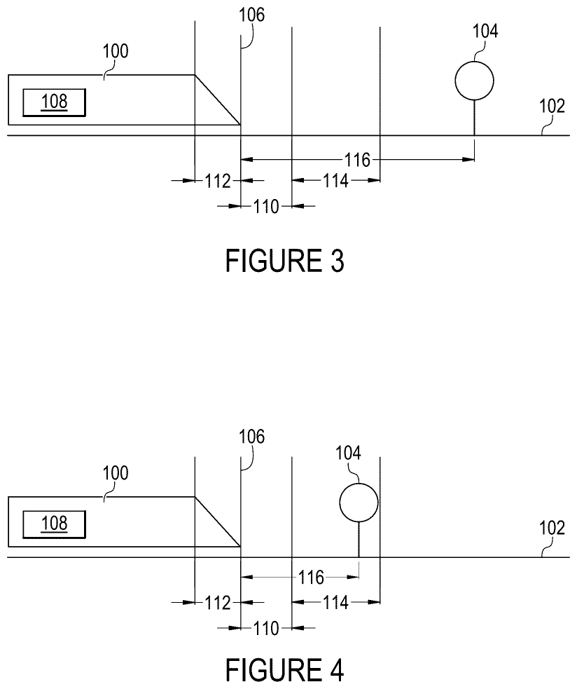

FIGS. 3-7 illustrate stages of a vehicle approaching a wayside device and passing the wayside device.

FIG. 3 illustrates one embodiment where a vehicle is approaching a wayside device outside a position uncertainty of the vehicle. The vehicle 100 on a route 102 has a position uncertainty 110 ahead of the leading edge 106 of the vehicle and a position uncertainty 112 behind the leading edge of the vehicle. The distance 116 between the leading edge of the vehicle and the wayside device is greater than the position uncertainty. The wayside device is not within the position uncertainty of the leading edge of the vehicle.

In some embodiments, the control circuit 108 may determine a buffer distance 114 in approach to the wayside device. The buffer distance may be based at least partly on a distance to be traveled before the vehicle comes to a stop. For example, the velocity, grade, mass, and braking system may affect the distance the vehicle travels before the vehicle comes to a stop. For example, the distance may be a minimum distance the vehicle requires to stop.

For example, the control circuit may determine whether the wayside device is located within a segment defined by the buffer distance plus the position uncertainty. For example, the segment may be equal to the buffer distance plus the position uncertainty. The distance 116 between the leading edge of the vehicle and the wayside device is greater than the segment.

In some embodiments, the control circuit may determine whether the wayside device is not located within a segment defined by the buffer distance plus the position uncertainty. For example, as shown in FIG. 3, the wayside device is not within the segment. The distance between the wayside device and the leading edge of the vehicle is greater than the distance defined by the segment.

As shown, the wayside device is not within the position uncertainty or the segment. A change in the status of the wayside device is likely not due to the vehicle, as the vehicle is not close enough to the wayside device to trigger a change in status of the wayside device. The vehicle may trigger a change in status of the wayside device when the leading edge of the vehicle reaches the wayside device.

The control circuit may control a user interface to indicate the change in status of the wayside device and the likelihood that the change in status of the wayside device was not due to the vehicle. For example, for a stop indication of the wayside device, the vehicle may be controlled by stopping the vehicle in advance of the wayside device or slowing the vehicle, or a combination thereof.

A PTC on-board segment may provide an indication on a user interface by changing the color or some other aspect of the signal icon on the track map, possibly accompanied by an audible alert. This may inform the crew that the leading edge of the vehicle is getting close to the calculated position uncertainty from the signal in case the intention is to stop before reaching the signal.

FIG. 4 illustrates an embodiment where a vehicle 100 is approaching a wayside device 104 along a route 102. The vehicle has a position uncertainty 110 ahead of the leading edge of the vehicle and a position uncertainty 112 behind the leading edge of the vehicle. The vehicle also has a buffer distance 114.

For example, an embodiment of the control circuit 108 may determine whether the wayside device is located within the position uncertainty. The distance 116 between the leading edge of the vehicle and the wayside device is greater than the position uncertainty. The wayside device is not within the position uncertainty distance.

For example, the control circuit may determine whether the wayside device is located within a segment defined by the buffer distance plus the position uncertainty. As shown, the distance between the leading edge of the vehicle and the wayside device is less than the segment. The wayside device is within the segment.

The PTC on-board segment may provide on a user interface an indication by changing the color or some other aspect of the signal icon on the track map, possibly accompanied by an audible alert. This will inform the crew that the leading edge of the train is getting close to the calculated position uncertainty, and is within the segment, from the signal in case the intention is to stop before reaching the signal.

For example, the wayside device is not within the position uncertainty but is within the segment. A change in the status of the wayside device is likely not due to the vehicle as the vehicle is not close enough to the wayside device to trigger a change in status of the wayside device. The control circuit may control a user interface to indicate the change in status of the wayside device and the likelihood that the change in status of the wayside device was not due to the vehicle. For example, for a stop indication of the wayside device, the vehicle may be controlled by stopping the vehicle in advance of the wayside device or slowing the vehicle, or a combination thereof. If the control circuit determines the vehicle triggered the change in status of the wayside device to “stop” then the vehicle may be allowed to proceed.

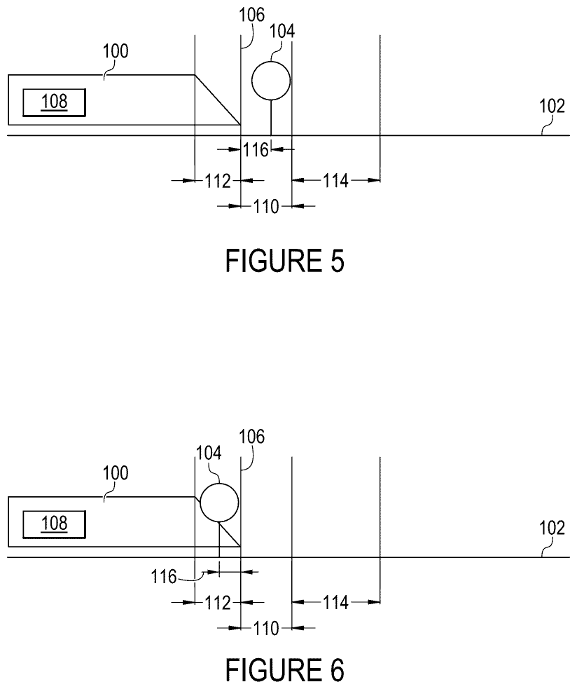

FIG. 5 illustrates an embodiment where a vehicle is approaching a wayside device along a route. The vehicle 100 has a position uncertainty 110 ahead of the leading edge of the vehicle and a position uncertainty 112 behind the leading edge of the vehicle. The distance 116 between the leading edge of the vehicle and the wayside device is less than the position uncertainty 110. The wayside device is within the position uncertainty distance.

For example, an embodiment the control circuit may determine whether the wayside device is located within the position uncertainty. As shown, the wayside device is within the position uncertainty distance.

For example, the control circuit may determine whether the wayside device is located within a segment defined by the buffer distance plus the position uncertainty. As shown, the distance between the leading edge of the vehicle and the wayside device is less than the segment. The wayside device is within the segment. As shown, the wayside device is within a distance defined by the segment.

The PTC on-board segment may provide on a user interface a second indication by changing the color or some other aspect of the signal icon on the track map, possibly accompanied by an audible alert. This will inform the crew that the wayside device is within the calculated position uncertainty of the leading edge of the vehicle in case the intention is to stop after passing the signal.

For example, the wayside device is within the position uncertainty and within the segment. A change in the status of the wayside device may be due to the vehicle since there is a possibility that the leading edge of the vehicle has reached the wayside device. The control circuit may indicate on a user interface the change in status of the wayside device and the likelihood that the change in status of the wayside device was due to the vehicle. The change in signal may be due to the vehicle passing the wayside device. For example, for a stop indication on the wayside device, the vehicle may be controlled by stopping the vehicle after of the wayside device or slowing the vehicle, or a combination thereof. The vehicle may also proceed by controlling the speed of the vehicle, such as maintaining the speed or increasing the speed depending on whether the vehicle triggered the stop indication on the wayside device. If the control circuit determines the vehicle triggered the change in status of the wayside device to “stop” then the vehicle may be allowed to proceed.

FIG. 6 illustrates an embodiment where a vehicle is passing a wayside device along a route. The leading edge 106 of the vehicle 100 is past the wayside device 104. The vehicle 100 has a position uncertainty 110 ahead of the leading edge of the vehicle and a position uncertainty 112 behind the leading edge of the vehicle. The vehicle also has a buffer distance 114.

For example, an embodiment of the control circuit 108 may determine whether the wayside device is located within the position uncertainty of the leading edge of the vehicle. As shown, the wayside device is within the position uncertainty distance. The distance 116 between the leading edge of the vehicle and the wayside device is less than the position uncertainty 112.

The PTC on-board segment may provide on a user interface a second indication by changing the color or some other aspect of the signal icon on the track map, possibly accompanied by an audible alert. This will inform the crew that the leading edge of the vehicle is within the calculated position uncertainty of the signal past the wayside device. This will inform the crew that the wayside device is within the calculated position uncertainty of the signal in case the intention is to stop after passing the wayside device.

For example, the wayside device is within the position uncertainty. A change in the status of the wayside device may be due to the vehicle passing the wayside device. The control circuit may indicate the change in status of the wayside device and the likelihood that the change in status of the wayside device was due to the vehicle. For example, for a stop indication of the wayside device, the vehicle may be controlled by stopping the vehicle after of the wayside device or slowing the vehicle, or a combination thereof. The vehicle may also proceed by controlling the speed of the vehicle, such as maintaining the speed or increasing the speed. If the control circuit determines the vehicle triggered the change in status of the wayside device to “stop”then the vehicle may be allowed to proceed.

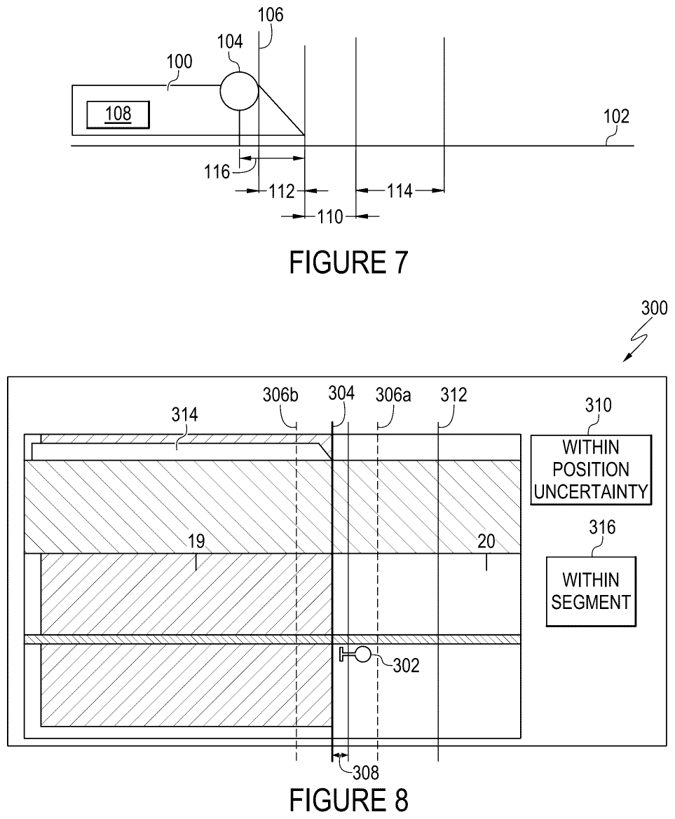

FIG. 7 illustrates an embodiment where a vehicle is beyond a wayside device along a route. The vehicle 100 has a position uncertainty 110 ahead of the leading edge of the vehicle and a position uncertainty 112 behind the leading edge of the vehicle. The distance 116 between the leading edge of the vehicle and the wayside device is greater than the position uncertainty. The wayside device is not within the position uncertainty.

For example, an embodiment of the control circuit may determine whether the wayside device is located within the position uncertainty. As shown, the wayside device is not within the position uncertainty distance behind the leading edge of the vehicle. The distance between the leading edge of the vehicle and the wayside device is greater than the position uncertainty distance.

The PTC on-board segment may control a user interface to return the signal icon to its original color, possibly accompanied by an audible alert. This will inform the crew that the leading edge of the train has passed the calculated position uncertainty of the signal.

For example, the wayside device is not within the position uncertainty behind the leading edge of the vehicle. A change in the status of the wayside device is likely be due to the vehicle. The control circuit may indicate the change in status of the wayside device and the likelihood that the change in status of the wayside device was due to the vehicle. The change in signal may be due to the vehicle passing the wayside device. For example, for a stop indication of the wayside device, the vehicle may also proceed by controlling the speed of the vehicle, such as maintaining the speed or increasing the speed. The vehicle may be controlled by stopping the vehicle after of the wayside device or slowing the vehicle, or a combination thereof.

FIG. 8 illustrates an embodiment of a user interface 300 for indicating position uncertainty of a vehicle in proximity to a wayside device. The user interface may be coupled to a control circuit located on-board a vehicle comprising a leading edge. The user interface may be controlled by an embodiment of the control circuit 108 of the vehicle 100 in FIGS. 1 and 3-7.

The user interface 300 may be configured to display a first icon 302 representing a wayside device. The first icon may change color based on a status of the wayside device, such as a stop or proceed indication. The first icon may change color based on whether the wayside device is within the position uncertainty or whether the wayside device is not within the position uncertainty. The first icon may also change color based on whether the wayside device is within or not within the segment of the position uncertainty and the buffer distance.

The user interface 300 may be configured to display a second icon 304 representing a leading edge of the vehicle. The user interface may display the vehicle 314 along the route. The user interface may also display a distance 308 between the leading edge of the vehicle and the wayside device.

The user interface 300 may be configured to display a third icon 306a, 306b representing the position uncertainty of the leading edge of the vehicle. The user interface may display the position uncertainty ahead of the leading edge of the vehicle and the position uncertainty behind the leading edge of the vehicle.

In some embodiments, the user interface may display an indication of whether the wayside device is within the position uncertainty. For example, an icon representing the wayside device may be displayed on the user interface. The icon may change color. The icon may be accompanied by an audible alert. This may inform the crew that the leading edge of the vehicle is getting close to the calculated position uncertainty from the signal in case the intention is to stop before reaching the signal.

For example, the color may be different based on whether the wayside device is within the position uncertainty, within the position uncertainty and buffer, outside the position uncertainty and buffer. The color may be different based on whether the vehicle is before or after the wayside signal.

The user interface 300 may be configured to display a fourth icon 310 representing an indication of whether the wayside device is within the position uncertainty. In some embodiments, the user interface may be configured to display the buffer 312 distance calculated by the control circuit. The buffer distance may be shown after the position uncertainty.

In some embodiments, based on the vehicle moving below a threshold speed, the user interface may be configured to display an icon representing the location of the wayside device and an indication of whether the wayside device is within the position uncertainty. For example, if the vehicle is moving above the threshold speed, the user interface may not display any indication. For example, the system may display information on the proximity to a wayside device only when the vehicle speed is below a specified threshold. For example, if the vehicle is moving at 50 mph toward a signal, the vehicle is not stopping at that signal. The user interface may not display any information or provide an alert. For example, if the train speed is 10 mph or below, then the vehicle may be stopping near the signal, the user interface may display information.

Based at least partly on whether the wayside device is located within the segment defined by the buffer distance plus the position uncertainty, the user interface may display an indication 316 that the wayside device is located within the segment defined by buffer distance plus the position uncertainty.

Based at least partly on the wayside device not being located within a segment defined by the buffer distance plus the position uncertainty, the user interface may be configured to display an indication that the wayside device is not located in within the segment defined by the buffer distance plus the position uncertainty.

In some embodiments, as the vehicle moves, the user interface may update the location of the vehicle. The user interface may show the movement of the vehicle along the route in relation to the wayside device. As the vehicle progresses down the route, the user interface may update the position of the vehicle along the route and in relation to the wayside device.

In some embodiments, the user interface may be configured to update the position uncertainty to the minimum distance upon receipt of a GPS signal. The user interface may be configured to display the change of the position uncertainty as the control circuit updates the position uncertainty. As the position uncertainty changes, the user interface may update the position uncertainty lines. As the vehicle moves along the route and on the user interface, the position uncertainty may move with the vehicle on the user interface. The user interface may also update the segment as the buffer distance and position uncertainty change.

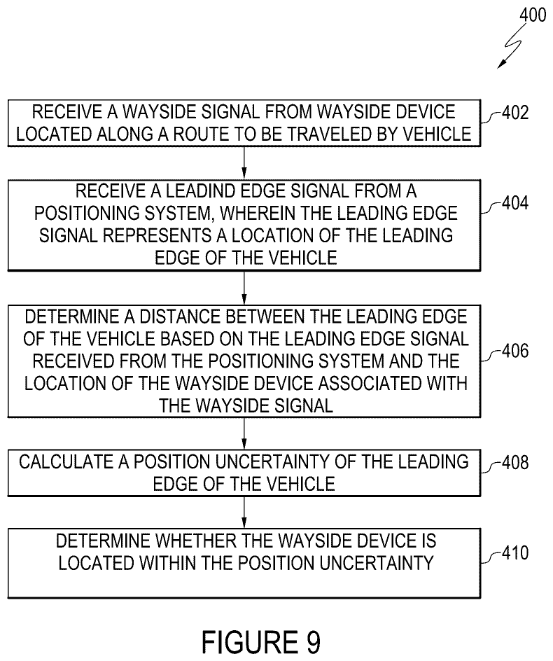

FIG. 9 illustrates one embodiment of a method 400 for determining position uncertainty of a vehicle in proximity to wayside devices. The method 400 may be implemented by an embodiment of the control circuit 108 of the vehicle 100 as described in FIGS. 1 and 3-7, with an embodiment of the user interface 300 shown in FIG. 8, and/or an embodiment of the vehicle control system 200 of the vehicle 202 shown in FIG. 2 with I/O devices 220.

In step 402, the control circuit may receive a wayside signal from a wayside device located along a route to be traveled by vehicle. The wayside signal may represent a location of the wayside device. The control circuit may be located on-board the vehicle. For example, the location of the wayside device may be GPS coordinate. The location of the wayside device may be a location along a route or a distance from the vehicle to the wayside device. In another embodiment, the location of the wayside device is known based on route data stored by the vehicle or based on route data received from the back office.

The wayside signal may also include a status of the wayside device. The status may be an indication if the vehicle may proceed, e.g., a stop indication or proceed indication.

In step 404, the control circuit may receive a leading edge signal from a positioning system. The leading edge signal may represent a location of the leading edge of the vehicle. The positioning system may be a GPS coordinate.

In step 406, the control circuit may determine a distance between the leading edge of the vehicle based at least partly on the leading edge signal received from the positioning system and the location of the wayside device associated with the wayside signal. For example, the control circuit may determine the distance between the leading edge of the vehicle and the location of the wayside device by comparing the location of the leading edge of the vehicle and the location of the wayside device.

In step 408, the control circuit may calculate a position uncertainty of the leading edge of the vehicle. The position uncertainty may be a distance from the leading edge of the vehicle. The position uncertainty may include a position uncertainty ahead of the vehicle's leading edge, a position uncertainty behind the vehicle's leading edge, or both. The position uncertainty ahead and behind may be the same.

For example, to determine the position uncertainty, an embodiment of the method may also include receiving a GPS signal. Based at least partly on the receipt of the GPS signal the control circuit may set the position uncertainty to a minimum distance. The control circuit may control the user interface to display the position uncertainty.

For example, to determine the position uncertainty, the method may also include receiving a GPS signal and upon receipt of the GPS signal, set the position uncertainty to a minimum distance. The minimum distance may be based at least partly on the speed of the vehicle. For example, after the receipt of the GPS signal the position uncertainty may be incremented based on at least one of an error in track size and/or an error in wheel size. In one embodiment, the position uncertainty may be reset in step 408 to the minimum distance upon receipt of a GPS signal and then the position uncertainty may be incrementally increased until the next GPS signal is received.

In step 410, the control circuit may determine whether a wayside device is located within the position uncertainty. For example, the control circuit may compare the position uncertainty with the distance from the leading edge of the vehicle to the wayside device. If the position uncertainty is greater than the distance from the leading edge of the vehicle to the wayside device, then the wayside device is within the position uncertainty. If the position uncertainty is less than the distance from the leading edge of the vehicle to the wayside device, then the wayside device is not within the position uncertainty.

Based at least partly on the location of the wayside device associated with the wayside signal and the calculated position uncertainty of the leading edge of the vehicle based on the leading edge signal, the control circuit may control a speed of the vehicle in motion or stop a movement of the vehicle. For example, controlling the speed of the vehicle may include decreasing the speed of the vehicle, maintaining the speed of the vehicle, or increasing the speed of the vehicle. For example, stopping the movement of the vehicle may include initiating the braking system.

One embodiment of the method 400 may also include displaying, by a user interface coupled to the control circuit, different icons. For example, the user interface can be controlled to display one or more of a first icon representing the location of the wayside device, a second icon representing the leading edge of the vehicle, a third icon representing the position uncertainty of the leading edge of the vehicle, and a fourth icon representing an indication of whether the wayside device is located within the position uncertainty. The method may also include creating audible indications.

In some embodiments, the method may also include displaying, by the user interface, an icon representing the location of the wayside device and an indication of whether the wayside device is located within the position uncertainty.

In some embodiments, the method may also include determining whether the vehicle is moving below a threshold speed. Based on the vehicle moving below a threshold speed, the user interface may be configured to display an icon representing the location of the wayside device and an indication of whether the wayside device is within the position uncertainty. For example, if the vehicle is moving above the threshold speed, the user interface may not display any indication. For example, the system may display information on the proximity to a wayside device only when the vehicle speed is below a specified threshold. For example, if the vehicle is moving at 50 mph toward a signal, the vehicle is not stopping at that signal. The user interface may not display any information or provide an alert. For example, if the train speed is 10 mph or below, then the vehicle may be stopping near the signal, the user interface may display information.

For example, the method may include the control circuit determining a buffer distance. The buffer distance may be based at least partly on a distance to be traveled by the vehicle to come to a stop. The control circuit may determine whether the wayside device is within a segment defined by the buffer distance plus the position uncertainty or whether the wayside device is not located within the segment defined by the buffer distance plus the position uncertainty.

For example, the method may include the control circuit incrementing the position uncertainty over time. The position uncertainty may be incremented based on at least one of an error in track size or error in a wheel size.

A suitable control circuit, or controller, may include an integrated circuit, a general purpose computing device, one or more processors, a memory device (e.g., forms of random access memory), a communications device (e.g., a modem, communications switch, or optical-electrical equipment).

In one embodiment, the control circuits, controllers or systems described herein may have a local data collection system deployed and may use machine learning to enable derivation-based learning outcomes. The control circuits may learn from and make decisions on a set of data (including data provided by various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the control circuit may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via backpropagation, feed forward processes, closed loop feedback, or open loop feedback. Alternatively, rather than using backpropagation, the machine learning system of the control circuit may use evolution strategies techniques to tune various parameters of the artificial neural network. The control circuits may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle control circuit executes that plan to achieve the desired input data to mirror the predicted best outcome scenario. Additionally, the success metric may be a combination of the optimized outcomes, which may be weighed relative to each other.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy). In one example, a method (e.g., for initializing a vehicle for movement under or with the protection of a vehicle control system) is provided. The method may include determining a sensed location of a vehicle based off one or more location signals received from an off-board source, and calculating a calculated location of the vehicle responsive to the vehicle moving into a blocking structure where the vehicle does not determine the sensed location of the vehicle based off the one or more location signals. The calculated location of the vehicle may be calculated using one or more sensor outputs. The method also may include selecting a route from among several routes within the blocking structure based on the calculated location, communicating the route that is selected to a back-office system, and controlling movement of the vehicle using one or more control signals received from the back-office system that are based on the route that is selected.

Optionally, the one or more controllers may receive the one or more location signals as GNSS signals received from one or more GNSS satellites as the off-board source. The one or more controllers may calculate the calculated location using one or more of vehicle speeds, vehicle vibrations, and/or vehicle headings as the one or more sensor outputs.

An apparatus for determining position uncertainty of a vehicle in proximity to a wayside device. The apparatus may include a control circuit located on-board a vehicle comprising a leading edge. The control circuit may be configured to receive a wayside signal from a wayside device positioned along a route to be traveled by the vehicle, where the wayside signal represents a location of the wayside device. The control circuit may be configured to receive a leading edge signal from a positioning system, where the leading edge signal represents a location of the leading edge of the vehicle. The control circuit may be configured to determine a distance between the leading edge of the vehicle based on the leading edge signal received from the positioning system and the location of the wayside device associated with the wayside signal. The control circuit may be configured to calculate a position uncertainty of the leading edge of the vehicle. The control circuit may be configured to determine whether the wayside device is within the position uncertainty. The apparatus may include each of these features alone or in combination.

The control circuit may be configured to determine a buffer distance, where the buffer distance is based on a distance to be traveled before the vehicle comes to a stop. The control circuit may be configured to determine whether the wayside device is located within a segment defined by the buffer distance plus the position uncertainty. The control circuit may include each of these features alone or in combination.

The control circuit may be configured to determine a buffer distance, where the buffer distance is based on a distance to be traveled before the vehicle comes to a stop. The control circuit may be configured to determine whether the wayside device is located within a segment defined by the buffer distance plus the position uncertainty. The control circuit may be configured to determine whether the wayside device is not located within a segment defined by the buffer distance plus the position uncertainty. The control circuit may include each of these features alone or in combination.

Alternatively, the positioning system may be a global positioning system (GPS), and the control circuit may be configured to receive a GPS signal; and upon receipt of the GPS signal, set the position uncertainty to a minimum distance. The control circuit may be configured to increment the position uncertainty over time. The control circuit may include each if these features alone or in combination.

Alternatively, the user interface may be coupled to the control circuit, where the user interface is configured to display an icon representing the location of the wayside device and an indication of whether the wayside device is within the position uncertainty. The user interface may include each of these features alone or in combination.

Alternatively, a user interface may be coupled to the control circuit, where the user interface is configured to display a first icon representing the location of the wayside device; a second icon representing the leading edge of the vehicle; a third icon representing the position uncertainty of the leading edge of the vehicle; and a fourth icon representing an indication of whether the wayside device is within the position uncertainty. The user interface may include each of these features alone or in combination.

An apparatus for indicating position uncertainty of a vehicle in proximity to a wayside device. The apparatus may include a user interface coupled to a control circuit located on-board a vehicle comprising a leading edge. The user interface may be configured to display a first icon representing a wayside device; a second icon representing the vehicle at a location of the vehicle; and an indication of whether the leading edge of the vehicle is within the position uncertainty or outside the position uncertainty. The apparatus may include each of these features alone or in combination.

The control circuit may be configured to determine a buffer distance, where the buffer distance is based on a distance to be traveled before the vehicle comes to a stop; and where the user interface may be configured to display the buffer distance. The control circuit may be configured to determine whether the wayside device is located within a segment defined by the buffer distance plus the position uncertainty and the user interface is configured to display an indication that the wayside device is located within the segment defined by buffer distance plus the position uncertainty. The apparatus may include each of these features alone or in combination.

Alternatively, the control circuit may be configured to determine a buffer distance, where the buffer distance is based on a distance to be traveled before the vehicle comes to a stop; and the user interface may be configured to display the buffer distance. The control circuit may be configured to determine whether the wayside device is not located within a segment defined by the buffer distance plus the position uncertainty and the user interface may be configured to display an indication that the wayside device is not located in within the segment defined by the buffer distance plus the position uncertainty thereof. The apparatus may include each of these features alone or in combination.

Alternatively, the control circuit may be configured to receive a global positioning system (GPS) signal; and based on the receipt of the GPS signal, the control circuit may set the position uncertainty to a minimum distance; and the user interface may be configured to update the position uncertainty to the minimum distance. The user interface may be coupled to the control circuit, and based on the vehicle moving below a threshold speed, the user interface may be configured to display an icon representing the location of the wayside device; and an indication of whether the wayside device is within the position uncertainty. The apparatus may include each of these features alone or in combination.

A method for determining position uncertainty of a vehicle in proximity to wayside devices. The method may include receiving a wayside signal from wayside device located along a route to be traveled by vehicle. The wayside signal represents a location of the wayside device. The method may include receiving a leading edge signal. The leading edge signal represents a location of the leading edge of the vehicle. The method may include determining a distance between the leading edge of the vehicle based on the leading edge signal and the location of the wayside device associated with the wayside signal; calculating a position uncertainty of the leading edge of the vehicle; and determining whether the wayside device is located within the position uncertainty. The method may include each of these features alone or in combination.

The method may include displaying an icon representing the location of the wayside device; an indication of whether the wayside device is located within the position uncertainty. The method may include receiving a global positioning signal (GPS); setting the position uncertainty to a minimum distance based on the GPS signal; and displaying the position uncertainty. The method may include each of these features alone or in combination.

Alternatively, the method may include determining a buffer distance, where the buffer distance is based on a distance to be traveled by the vehicle to come to a stop; and either determining whether the vehicle is within a segment defined by the buffer distance plus the position uncertainty; or determining whether the wayside device is not located within the segment defined by the buffer distance plus the position uncertainty. The method may include determining whether the vehicle is moving below a threshold level; and based on the vehicle moving below a threshold speed, displaying an icon representing the location of the wayside device; and an indication of whether the wayside device is within the position uncertainty. The method may include each of these features alone or in combination.

The method for determining position uncertainty of a vehicle in proximity to wayside devices may include receiving, by a control circuit located on-board a vehicle comprising a leading edge, a wayside signal from wayside device located along a route to be traveled by vehicle. The wayside signal represents a location of the wayside device. The method may include receiving, by the control circuit, a leading edge signal from a positioning system. The leading edge signal represents a location of the leading edge of the vehicle. The method may include determining, by the control circuit, a distance between the leading edge of the vehicle based on the leading edge signal received from the positioning system and the location of the wayside device associated with the wayside signal; calculating, by the control circuit, a position uncertainty of the leading edge of the vehicle; and determining, by the control circuit, whether the wayside device is located within the position uncertainty. The method may include each of these features alone or in combination.

The method may include displaying, by a user interface coupled to the control circuit an icon representing the location of the wayside device; and an indication of whether the wayside device is located within the position uncertainty. The method may include receiving, by a position system including a global position system (GPS), a GPS signal; setting, by the control circuit, the position uncertainty to a minimum distance based on the receipt of the GPS signal; and displaying, by the user interface, the position uncertainty. The method may include each of these features alone or in combination.

Alternatively, the method may include determining, by the control circuit, a buffer distance, where the buffer distance is based on a distance to be traveled by the vehicle to come to a stop; and either determining, by the control circuit, whether the vehicle is within a segment defined by the buffer distance plus the position uncertainty; or determining, by the control circuit, whether the wayside device is not located within the segment defined by the buffer distance plus the position uncertainty. The method may include incrementing the position uncertainty based on at least one of an error in track size or error in a wheel size. The method may include each of these features alone or in combination.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. An apparatus for determining position uncertainty of a vehicle in proximity to a wayside device, the apparatus comprising:
a control circuit located on-board a vehicle comprising a leading edge, wherein the control circuit is configured to:
receive a wayside signal from a wayside device positioned along a route to be traveled by the vehicle, wherein the wayside signal represents a location of the wayside device;
receive a leading edge signal from a positioning system, wherein the leading edge signal represents a location of the leading edge of the vehicle;
determine a distance between the leading edge of the vehicle based on the leading edge signal received from the positioning system and the location of the wayside device associated with the wayside signal;
calculate a position uncertainty of the leading edge of the vehicle; and
determine whether the wayside device is within the position uncertainty.

2. The apparatus of claim 1, comprising:
a user interface coupled to the control circuit, wherein the user interface is configured to display:
an icon representing the location of the wayside device; and
an indication of whether the wayside device is within the position uncertainty.

3. The apparatus of claim 1, wherein the control circuit is configured to:
determine a buffer distance, wherein the buffer distance is based on a distance to be traveled before the vehicle comes to a stop.

4. The apparatus of claim 3, wherein the control circuit is configured to determine whether the wayside device is located within a segment defined by the buffer distance plus the position uncertainty.

5. The apparatus of claim 3, wherein the control circuit is configured to determine whether the wayside device is not located within a segment defined by the buffer distance plus the position uncertainty.

6. The apparatus of claim 1, wherein the positioning system is a global positioning system (GPS), and wherein the control circuit is configured to:
receive a GPS signal; and
upon receipt of the GPS signal, set the position uncertainty to a minimum distance.

7. The apparatus of claim 6, wherein the control circuit is configured to increment the position uncertainty over time.

8. The apparatus of claim 1, comprising:
a user interface coupled to the control circuit, based on the vehicle moving below a threshold speed, the user interface is configured to display:
an icon representing the location of the wayside device; and
an indication of whether the wayside device is within the position uncertainty.

9. An apparatus for indicating position uncertainty of a vehicle in proximity to a wayside device, the apparatus comprising:
a user interface coupled to a control circuit located on-board a vehicle comprising a leading edge, wherein the user interface is configured to display:
a first icon representing a wayside device at a location of the wayside device;
a second icon representing the vehicle at a location of the vehicle; and
an indication of whether the wayside device is within the position uncertainty or outside the position uncertainty.

10. The apparatus of claim 9, wherein the control circuit is configured to:
determine a buffer distance, wherein the buffer distance is based on a distance to be traveled before the vehicle comes to a stop; and
wherein the user interface is configured to display the buffer distance.

11. The apparatus of claim 10, wherein the control circuit is configured to determine whether the wayside device is located within a segment defined by the buffer distance plus the position uncertainty and wherein the user interface is configured to display an indication that the wayside device is located within the segment defined by buffer distance plus the position uncertainty.

12. The apparatus of claim 10, wherein the control circuit is configured to determine whether the wayside device is not located within a segment defined by the buffer distance plus the position uncertainty and wherein the user interface is configured to display an indication that the wayside device is not located in within the segment defined by the buffer distance plus the position uncertainty.

13. The apparatus of claim 9, wherein the control circuit is configured to:
receive a global positioning system (GPS) signal; and
based on a receipt of the GPS signal, set the position uncertainty to a minimum distance; and
wherein the user interface is configured to update the position uncertainty to the minimum distance.

14. The apparatus of claim 10, comprising:
a user interface coupled to the control circuit, and based on the vehicle moving below a threshold speed, the user interface is configured to display:
an icon representing the location of the wayside device; and
an indication of whether the wayside device is within the position uncertainty.

15. A method for determining position uncertainty of a vehicle in proximity to wayside devices, the method comprising:
receiving a wayside signal, wherein the wayside signal represents a location of a wayside device;
receiving a leading edge signal, wherein the leading edge signal represents a location of a leading edge of the vehicle;
determining a distance between the leading edge of the vehicle based on the leading edge signal and the location of the wayside device associated with the wayside signal;
calculating a position uncertainty of the leading edge of the vehicle; and
determining whether the wayside device is located within the position uncertainty.

16. The method of claim 15, comprising displaying, by a user interface coupled to a control circuit:
an icon representing the location of a wayside device; and
an indication of whether the wayside device is located within the position uncertainty.

17. The method of claim 16, comprising:
receiving a global position system (GPS);
setting the position uncertainty to a minimum distance based on the GPS signal; and
displaying the position uncertainty.

18. The method of claim 15, comprising:
determining a buffer distance, wherein the buffer distance is based on a distance to be traveled by the vehicle to come to a stop; and either
determining whether the wayside device is within a segment defined by the buffer distance plus the position uncertainty; or
determining whether the wayside device is not located within the segment defined by the buffer distance plus the position uncertainty.

19. The method of claim 18, comprising:
determining whether the vehicle is moving below a threshold speed; and
based on the vehicle moving below a threshold speed, displaying:
an icon representing the location of the wayside device; and
an indication of whether the wayside device is within the position uncertainty.

20. The method of claim 19, comprising incrementing the position uncertainty based on at least one of an error in track size or error in a wheel size.
